(19) United States
(12) Patent Application Publication
(10) Pub. No.: US 2012/0110078 A1
(43) Pub. Date: May 3, 2012

(54) APPLICATION EXECUTION CONTROL APPARATUS AND APPLICATION EXECUTION CONTROL METHOD

(75) Inventor: Ansley YEO, Ome-shi (JP)

(73) Assignee: KABUSHIKI KAISHA TOSHIBA, Tokyo (JP)

(21) Appl. No.: 13/206,377

(22) Filed: Aug. 9, 2011

(30) Foreign Application Priority Data
Oct. 29, 2010 (JP) 2010-244522

(51) Int. Cl. G06F 15/16

(52) U.S. Cl. 709/204

(57) ABSTRACT

According to one embodiment, an application execution control apparatus includes a memory, a wireless communication module, and a controller. The memory is configured to store a relationship between a first application and a first wireless communication device, and a relationship between a second application and a second wireless communication device. The wireless communication module is configured to make a wireless communication with one of the first wireless communication device and the second wireless communication device. The controller is configured to select the first application based on the wireless communication with the first wireless communication device, and to select the second application based on the wireless communication with the second wireless communication device.

### CROSS-REFERENCE TO RELATED APPLICATIONS

This application is based upon and claims the benefit of priority from Japanese Patent Application No. 2010-244522, filed Oct. 29, 2010; the entire contents of which are incorporated herein by reference.

### FIELD

Embodiments described herein relate generally to an application execution control apparatus and application execution control method.

### BACKGROUND

For example, when the user runs an application on a personal computer (PC), he or she inputs, for example, a password to the PC. The PC accepts a login to the application under the condition that the input password matches with a registered password, and permits the user to use the application.

When a plurality of users use a single PC, they can use a common application using a common registered password, or they can use different applications using different registered passwords.

The selection procedure of the application (a login to the application) corresponding to the password input is inconvenient for the user.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view showing an example of a wireless communication device according to the first to fourth embodiments;

FIG. 2 is a view showing an example of first application execution control according to the first embodiment;

FIG. 3 is a view showing an example of second application execution control, third application execution control, and fourth application execution control according to the second, third, and fourth embodiments;

FIG. 4 is a table showing an example of user management information according to the first to fourth embodiments;

FIG. 5 is a flowchart for explaining an example of the first application execution control according to the first embodiment;

FIG. 6 is a flowchart for explaining an example of the second application execution control according to the second embodiment;

FIG. 7 is a flowchart for explaining an example of the third application execution control according to the third embodiment; and

FIG. 8 is a flowchart for explaining an example of the fourth application execution control according to the fourth embodiment.

### DETAILED DESCRIPTION

Various embodiments will be described hereinafter with reference to the accompanying drawings.

In general, according to one embodiment, an application execution control apparatus includes a memory, a wireless communication module, and a controller. The memory is configured to store a relationship between a first application and a first wireless communication device, and a relationship between a second application and a second wireless communication device. The wireless communication module is configured to make a wireless communication with one of the first wireless communication device and the second wireless communication device. The controller is configured to select the first application based on the wireless communication with the first wireless communication device, and to select the second application based on the wireless communication with the second wireless communication device.

The first to fourth embodiments will be described hereinafter with reference to the drawings.

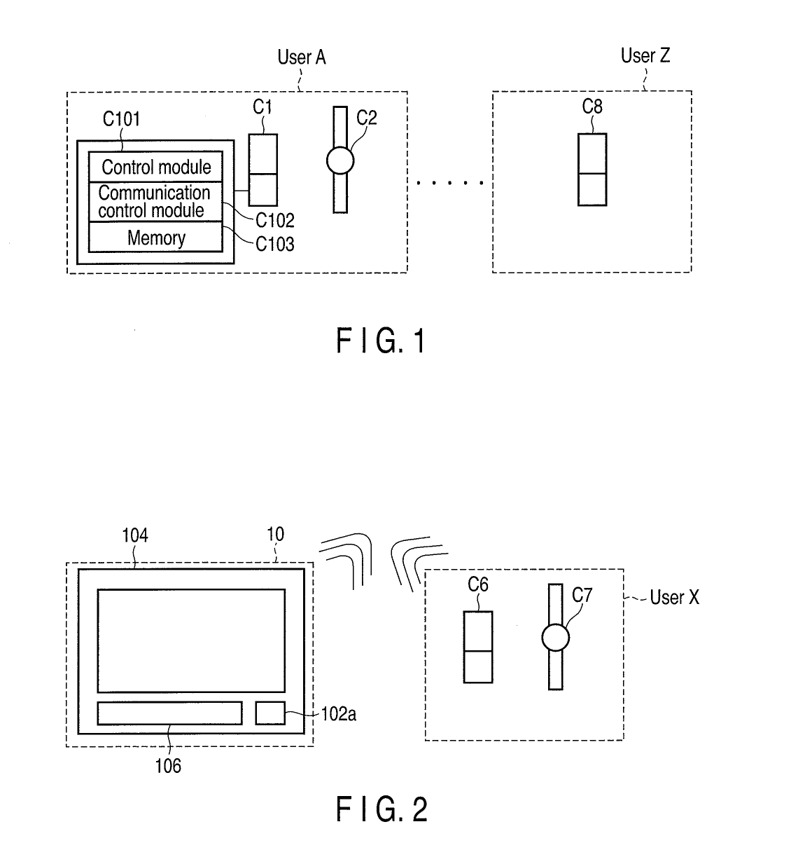

Initially, common parts of the first to fourth embodiments will be described below with reference to FIGS. 1, 2, and 3. As shown in FIGS. 1, 2, and 3, an application execution system is configured by an application execution apparatus 10, and wireless communication devices C1 to C8. The application execution apparatus 10 includes, for example, a digital TV or personal computer (PC). Wireless communication devices C1 to C8 include, for example, a mobile phone or watch.

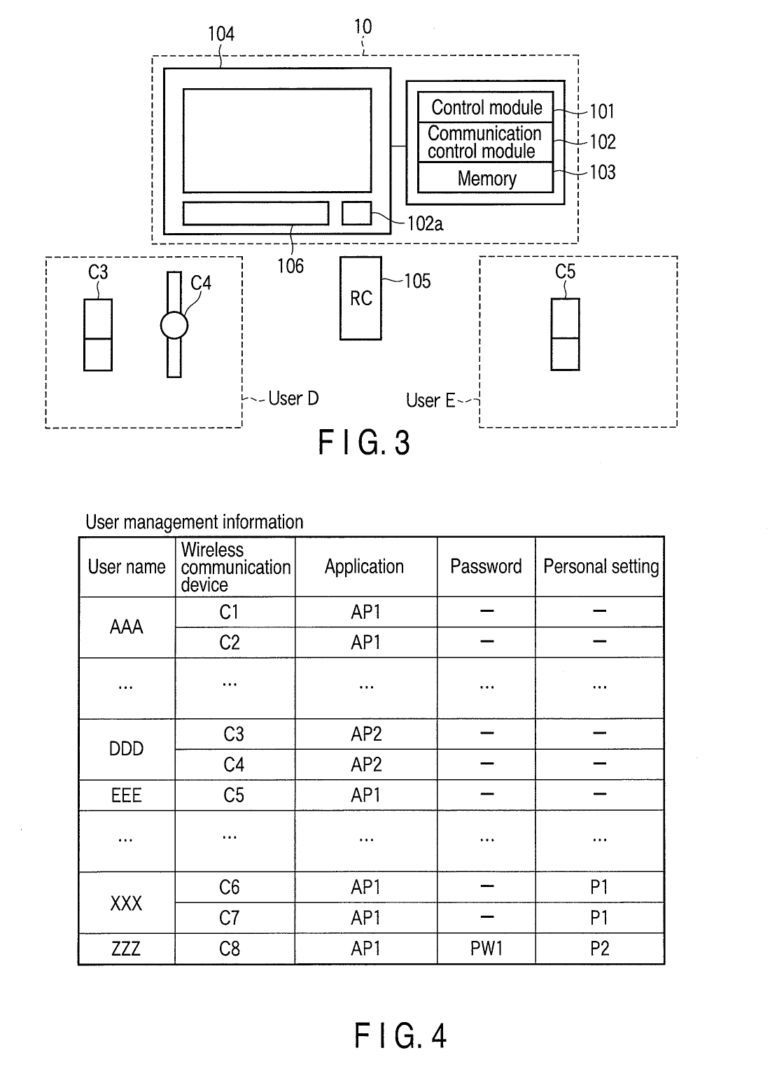

As shown in FIG. 3, for example, the application execution apparatus 10 includes a control module (controller) 101, communication control module (wireless communication module) 102, transmitter/receiver (wireless communication module) 102a, memory 103, information output module 104, remote controller 105, and operation input unit 106.

The control module 101 is configured by, for example, a CPU, and controls execution of an application. Note that the application execution control will be described in detail later. The communication control module 102 supports wireless communications based on, for example, the Bluetooth® standard (that is, it supports wireless communication based on the Bluetooth Low Energy [BLE] Proximity Profile), and is configured to receive or transmit a signal via the transmitter/receiver 102a.

The memory 103 stores, for example, applications AP1 and AP2. Applications AP1 and AP2 are compliant with, for example, the Bluetooth standard (BLE Proximity Profile), and correspond to, for example, Skype® or MSN Messenger®. Each of applications AP1 and AP2 permits a login of one user (one device) at the same time. In other words, each of applications AP1 and AP2 does not permit logins of a plurality of users (a plurality of devices) at the same time. The memory 103 stores (registers) user management information shown in FIG. 4. The information output module 104 is, for example, a display unit.

The remote controller 105 is a controller which comes with the application execution apparatus 10. When the application execution apparatus 10 is a digital TV, the remote controller 105 is that for the TV, which includes a plurality of keys used to select a broadcast program and channel.

Note that FIG. 2 illustrates the application execution apparatus 10 while omitting illustrations of some components. However, the application execution apparatus 10 shown in FIG. 2 is the same as that shown in FIG. 3.

Also, as shown in FIG. 1, wireless communication device C1 includes a control module C101, communication control module C102, transmitter/receiver C102a, and memory C103. The control module C101 is configured by, for example, a CPU. The communication control module C102 supports wireless communications based on, for example, the Bluetooth® standard (that is, it supports wireless communications based on the Bluetooth Low Energy [BLE] Proximity Profile), and is configured to receive or transmit a signal via the transmitter/receiver C102a.

FIGS. 1, 2, and 3 illustrate wireless communication devices C2 to C8 while omitting illustrations of some components. However, the basic arrangement of each of wireless communication devices C2 to C8 shown in FIGS. 1, 2, and 3 is the same as that of wireless communication device C1 shown in FIG. 1.

An example of user management information will be described below with reference to FIG. 4. For example, the user management information registers a relationship between a user name AAA (user A), wireless communication devices C1 and C2 (items of identification information of wireless communication devices C1 and C2), and application AP1. Furthermore, the user management information registers a relationship between a user name DDD (user D), wireless communication devices C3 and C4 (items of identification information of wireless communication devices C3 and C4), and application AP2. Moreover, the user management information registers a relationship between a user name EEE (user E), wireless communication device C5 (identification information of wireless communication device C5), and application AP1. Also, the user management information registers a relationship between a user name XXX (user X), wireless communication devices C6 and C7 (items of identification information of wireless communication devices C6 and C7), application AP1, and a personal setting P1. In addition, the user management information registers a relationship between a user name ZZZ (user Z), wireless communication device C8 (identification information of wireless communication device C8), application AP1, a password PW1, and a personal setting P2.

### First Embodiment

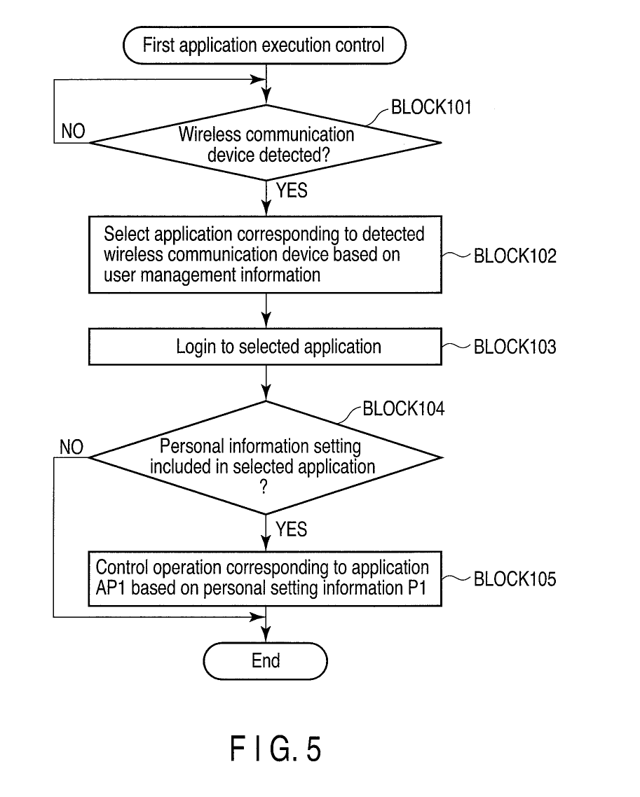

The first embodiment will be described below with reference to FIGS. 2, 4, and 5. FIG. 2 is a view for explaining first application execution control corresponding to the first embodiment. FIG. 5 is a flowchart showing an example of the first application execution control corresponding to the first embodiment.

The control module 101 of the application execution apparatus 10 can detect wireless communication devices C1 to C8 (items of identification information of wireless communication devices C1 to C8) from statuses of wireless communications (for example, wireless communications based on the BLE Proximity Profile) of the communication control module 102. For example, when the communication control module 102 establishes a wireless communication with wireless communication device C6, the control module 101 detects wireless communication device C6 in response to this establishment of the wireless communication (YES in BLOCK 101), selects application AP1 based on the user management information (BLOCK 102), and accepts a login to application AP1 (BLOCK 103). That is, upon detection of wireless communication device C6, the control module 101 controls to launch application AP1 based on the user management information. Furthermore, the control module 101 can also control based on the user management information to output information indicating that the login has been made by user name XXX, in response to detection of wireless communication device C6. In response to this information, the information output module 104 outputs (displays) information indicating that the login has been made by user name XXX.

That is, when user X who owns wireless communication device C6 comes closer to the application execution apparatus 10, and wireless communication device C6 enters a communication area of the communication control module 102, login processing to application AP1 is automatically complete. That is, user X who owns wireless communication device C6 need only come closer to the application execution apparatus 10, and can use application AP1 to which the login is automatically complete.

For example, if application AP1 is a communication application which allows various communication services by accessing an external server, user X who owns wireless communication device C6 can use various communication services based on application AP1 by only coming closer to the application execution device 10. If application AP1 is an application which executes to output a predetermined broadcast, user X who owns wireless communication device C6 can begin to watch the predetermined broadcast by only coming closer to the application execution apparatus 10.

Furthermore, when personal setting P1 is associated with wireless communication device C6 (YES in BLOCK 104), the control module 101 selects application AP1 in response to detection of wireless communication device C6, accepts a login to application AP1, and further controls (executes) an operation corresponding to application AP1 based on personal setting P1 (BLOCK 105).

For example, when personal setting P1 is address information which designates a predetermined site, the control module 101 controls to activate the application execution apparatus 10 (digital TV), to launch application AP1 (for example, a browser), to access the predetermined site, to receive information of the predetermined site, and to output (display) the information of the predetermined site. That is, user X who owns wireless communication device C6 can watch the information of the predetermined site by only coming closer to the application execution apparatus 10.

Alternatively, when personal setting P1 is information which designates selection of a sports channel of a predetermined broadcast and designates a predetermined volume value, the control module 101 activates the application execution apparatus 10 (digital TV), selects the sports channel of the predetermined broadcast, outputs an image of the sports channel, and also outputs an audio controlled to have the predetermined volume value. That is, user X who owns wireless communication device C6 can begin to watch the sports channel of the predetermined broadcast by only coming closer to the application execution apparatus 10.

Note that the case has been described wherein user X who owns wireless communication device C6 comes closer to the application execution apparatus 10 to automatically complete the login processing to application AP1. Likewise, for example, when user A who owns wireless communication device C1 comes closer to the application execution apparatus 10, login processing to application AP1 is automatically complete. Also, when user A who owns wireless communication device C2 comes closer to the application execution apparatus 10, login processing to application AP1 is automatically complete.

When user A who owns wireless communication device C8 comes closer to the application execution apparatus 10, and the control module 101 detects wireless communication device C8 based on a wireless communication, the control module 101 requests user A to input a password based on the user management information. In response to this, the information output module 104 displays a message indicating that a password input is required. For example, the user inputs a password via wireless communication device C8, the remote controller 105 which comes with the application execution apparatus 10, or operation input unit 106. When the input password matches a registered password (password PW1), the control module 101 selects application AP1, and accepts a login to application AP1. That is, when the control module 101 detects wireless communication device C8 and an authentic password is input, it controls to launch application AP1.

### Second Embodiment

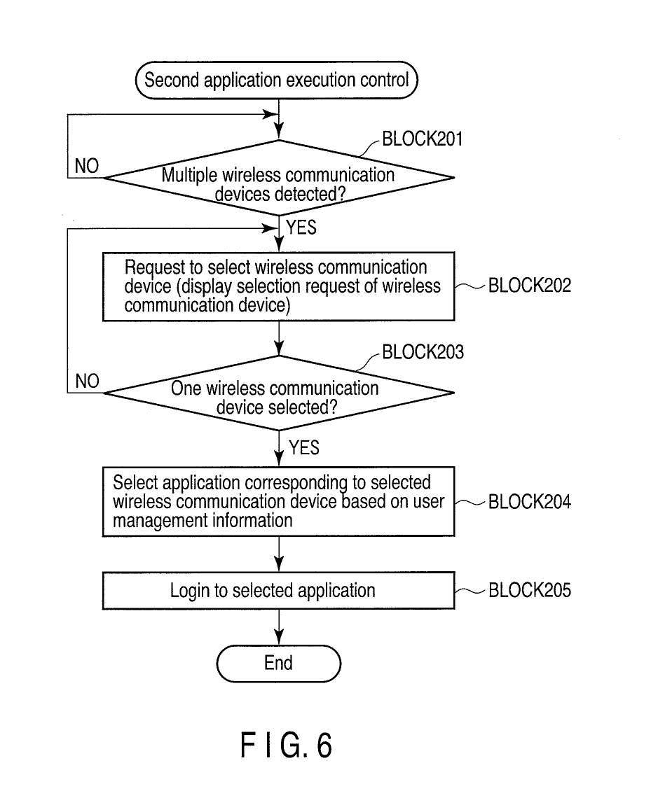

The second embodiment will be described below with reference to FIGS. 3, 4, and 6. FIG. 3 is a view for explaining second application execution control corresponding to the second embodiment. FIG. 6 is a flowchart showing an example of the second application execution control corresponding to the second embodiment.

The control module 101 of the application execution apparatus 10 can detect wireless communication devices C1 to C8 (items of identification information of wireless communication devices C1 to C8) from statuses of wireless communications (for example, wireless communications based on the BLE Proximity Profile) of the communication control module 102. For example, when the communication control module 102 detects a plurality of wireless communication devices, for example, wireless communication devices C3 and C5 (YES in BLOCK 201), the control module 101 requests to select one of wireless communication devices C3 and C5 (BLOCK 202). In response to this request, the information output module (notification module) 104 displays a message indicating that one of wireless communication devices C3 and C5 is required to be selected (BLOCK 202). Alternatively, the information output module 104 displays a message indicating that one of users D and E is required to be selected. For example, user D can select wireless communication device C3 (or wireless communication device C5) via wireless communication device C3, remote controller 105, or operation input unit 106. Also, user E can select wireless communication device C5 (or wireless communication device C3) via wireless communication device C5, remote controller 105, or operation input unit 106.

In response to selection of wireless communication device C3 (YES in BLOCK 203), the control module 101 selects application AP2 based on the user management information (BLOCK 204), and accepts a login to application AP2 (BLOCK 205). That is, the control module 101 controls to launch application AP2 based on the user management information in response to selection of wireless communication device C3. Furthermore, in response to selection of wireless communication device C3, the control module 101 can control based on the user management information to output information indicating that the login has been made by user name DDD. In response to this, the information output module 104 outputs (displays) information indicating that the login has been made by user name DDD.

Alternatively, in response to selection of wireless communication device C5 (YES in BLOCK 203), the control module 101 selects application AP1 based on the user management information (BLOCK 204), and accepts a login to application AP1 (BLOCK 205). That is, the control module 101 controls to launch application AP1 based on the user management information in response to selection of wireless communication device C5. Furthermore, in response to selection of wireless communication device C5, the control module 101 can control based on the user management information to output information indicating that login has been made by user name EEE. In response to this, the information output module 104 outputs (displays) information indicating that the login has been made by user name EEE.

That is, when user D who owns wireless communication device C3 and user E who owns wireless communication device C5 come closer to the application execution apparatus 10 nearly at the same time (within a predetermined period), and wireless communication devices C3 and C5 enter the communication area of the communication control module 102, the application execution apparatus 10 requests to select one of wireless communication devices C3 and C5. In response to this request, when wireless communication device C3 is selected, the application execution apparatus 10 automatically completes login processing to application AP2 by wireless communication device C3. On the other hand, when wireless communication device C5 is selected, the application execution apparatus 10 automatically completes login processing to application AP1 by wireless communication device C5. That is, even when two or more wireless communication devices enter the communication area of the communication control module 102 at nearly the same time, login processing by one of the two or more wireless communication devices can be automatically complete.

### Third Embodiment

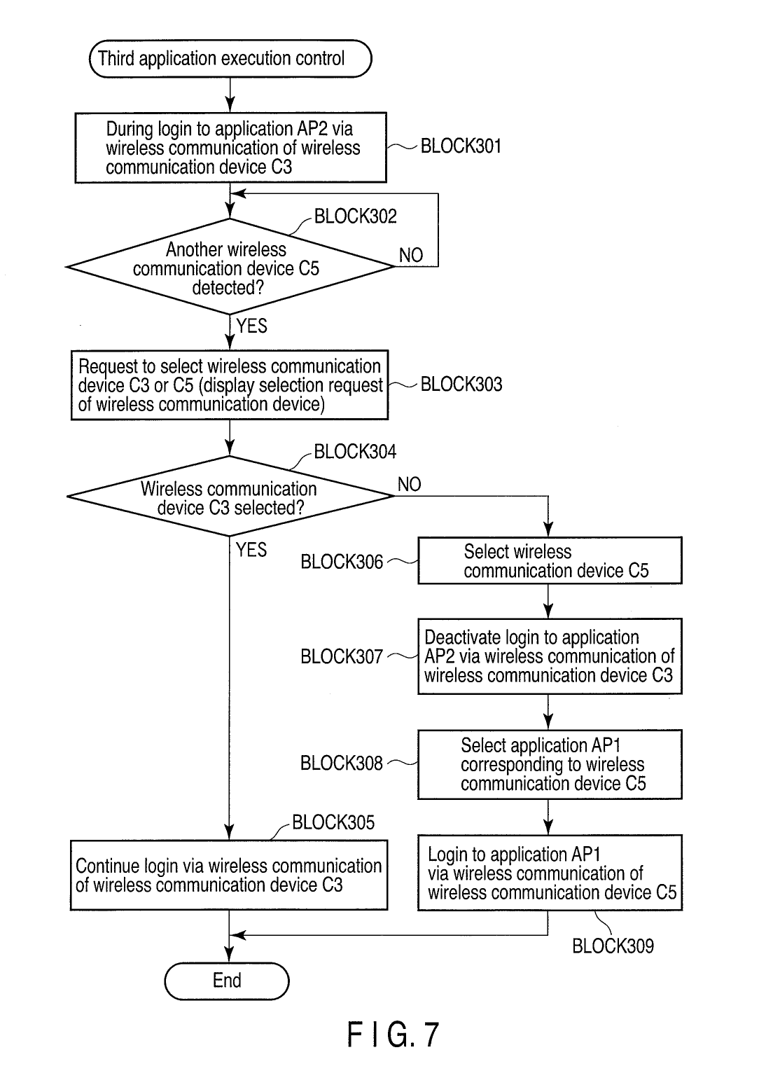

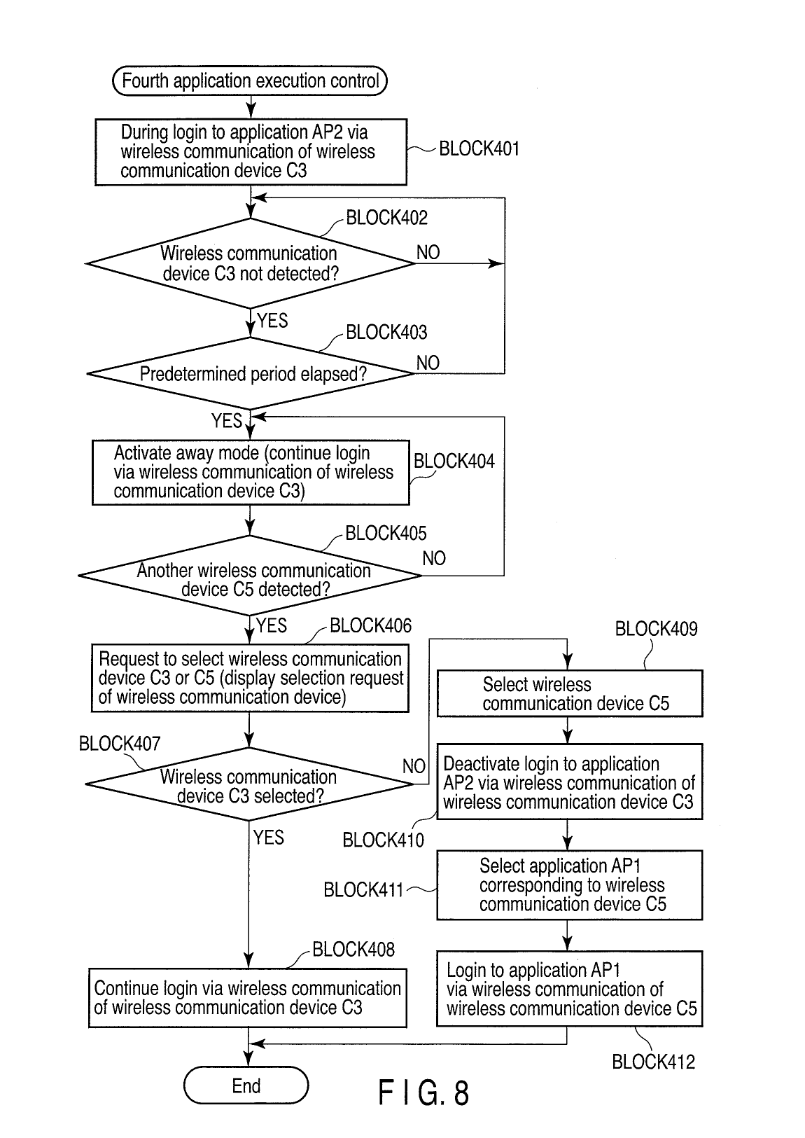

The third embodiment will be described below with reference to FIGS. 3, 4, and 7. FIG. 3 is a view for explaining third application execution control corresponding to the third embodiment (a view for explaining the second application execution control and third application execution control). FIG. 7 is a flowchart showing an example of the third application execution control corresponding to the third embodiment.

In a state in which application AP2 has already been logged in via a wireless communication of one wireless communication device, for example, wireless communication device C3 (BLOCK 301), when the control module 101 detects another wireless communication device, for example, wireless communication device C5 (identification information of wireless communication device C5) based on statuses of wireless communications (for example, wireless communications based on the BLE Proximity Profile) of the communication control module 102 (YES in BLOCK 302), the control module 101 requests to select one of wireless communication devices C3 and C5 (BLOCK 303). In response to this request, the information output module 104 displays a message indicating that one of the login wireless communication device C3 and wireless communication device C5 which can login is required to be selected (BLOCK 303). Alternatively, the information output module 104 displays a message indicating that one of the login user D and user E who can login is required to be selected. For example, user D can select wireless communication device C3 or designate to continue the login via wireless communication device C3, remote controller 105, or operation input unit 106. Alternatively, user E can select wireless communication device C5 or designate switching of the login user via wireless communication device C5, remote controller 105, or operation input unit 106.

In response to selection of wireless communication device C3 (YES in BLOCK 304), the control module 101 continues the login via the wireless communication of wireless communication device C3 based on the user management information (BLOCK 305), and continues to execute application AP2. Furthermore, in response to selection of wireless communication device C3, the control module 101 can also control based on the user management information to output information indicating that the login by user name DDD is continued. In response to this, the information output module 104 outputs (displays) information indicating that the login by user name DDD is continued.

Alternatively, in response to selection of wireless communication device C5 (NO in BLOCK 304) (BLOCK 306), the control module 101 deactivates the login to application AP2 (logoff) via the wireless communication of wireless communication device C3 (BLOCK 307), selects application AP1 based on the user management information (BLOCK 308), and accepts a login to application AP1 via a wireless communication of wireless communication device C5 (BLOCK 309). That is, in response to selection of wireless communication device C5, the control module 101 controls to launch application AP2 based on the user management information. Furthermore, in response to selection of wireless communication device C5, the control module 101 can also control based on the user management information to output information indicating that the login by user name DDD was deactivated (logoff), and the login has been done by user name EEE. In response to this, the information output module 104 outputs (displays) information indicating that the login by user name DDD was deactivated (logoff), and the login has been done by user name EEE.

That is, in a state in which application AP2 has already been logged in via the wireless communication of wireless communication device C3, when user E who owns wireless communication device C5 comes closer to the application execution apparatus 10, and wireless communication device C5 enters the communication area of the communication control module 102, the application execution apparatus 10 requests to select one of wireless communication devices C3 and C5. In response to this request, when wireless communication device C3 is selected, the application execution apparatus 10 automatically continues the login to application AP2 via the wireless communication of wireless communication device C3. On the other hand, when wireless communication device C5 is selected, the application execution apparatus 10 deactivates the login to application AP2 via the wireless communication of wireless communication device C3, and automatically switches login processing to application AP1 via a wireless communication of wireless communication device C5. That is, even when a second wireless communication device as another wireless communication device enters the communication area of the communication control module 102 during the login by a first wireless communication device, the login by the first wireless communication device can be continued, or the login by the first wireless communication device can be switched to that by the second wireless communication device by a simple operation.

### Fourth Embodiment

The fourth embodiment will be described below with reference to FIGS. 3, 4, and 8. FIG. 3 is a view for explaining fourth application execution control corresponding to the fourth embodiment (a view for explaining the second application execution control, third application execution control, and fourth application execution control). FIG. 8 is a flowchart showing an example of the fourth application execution control corresponding to the fourth embodiment.

In a state in which application AP2 has already been logged in via a wireless communication of one wireless communication device, for example, wireless communication device C3 (BLOCK 401), when the control module 101 detects that a non-detection state of wireless communication device C3 exceeds a predetermined period (YES in BLOCK 402) (YES in BLOCK 403), it activates an away mode (BLOCK 404) to continue the login state. Note that the control module 101 includes a timer, which counts a non-detection period. When the control module 101 detects wireless communication device C3 again, it cancels the away mode. In this way, for example, when user D who owns wireless communication device C3 temporarily separates from the application execution apparatus 10, and comes closer to the application execution apparatus 10 again, user D can immediately use application AP2.

During activation of the aforementioned away mode (BLOCK 404), when the control module 101 detects another wireless communication device, for example, wireless communication device C5 (identification information of wireless communication device C5) based on statuses of wireless communications (for example, wireless communications based on the BLE Proximity Profile) of the communication control module 102 (YES in BLOCK 405), it requests to select one of wireless communication devices C3 and C5 (BLOCK 406). In response to this request, the information output module 104 displays a message indicating that one of the login wireless communication device C3 in the away mode and wireless communication device C5 which can login is required to be selected (BLOCK 406). Alternatively, the information output module 104 displays a message indicating that one of the login user D in the away mode and user E who can login is required to be selected. Alternatively, the information output module displays a message indicating that change/non-change of the login user is required to be selected. For example, user E can select wireless communication device C3 or C5 or designate change of the login user via wireless communication device C5, remote controller 105, or operation input unit 106.

In response to selection of wireless communication device C3 (YES in BLOCK 407), the control module 101 continues the login via the wireless communication of wireless communication device C3 based on the user management information (BLOCK 408), and continues to execute application AP2. Furthermore, in response to selection of wireless communication device C3, the control module 101 can control based on the user management information to output information indicating that the login by user name DDD is continued. In response to this, the information output module 104 outputs (displays) information indicating that the login by user name DDD is continued.

Alternatively, in response to selection of wireless communication device C5 (NO in BLOCK 407) (BLOCK 409), the control module 101 deactivates the login to application AP2 (logoff) via the wireless communication of wireless communication device C3 (BLOCK 410), selects application AP1 based on the user management information (BLOCK 411), and accepts a login to application AP1 via a wireless communication of wireless communication device C5 (BLOCK 412). That is, in response to selection of wireless communication device C5, the control module 101 controls to launch application AP1 based on the user management information. Furthermore, in response to selection of wireless communication device C5, the control module 101 can also control based on the user management information to output information indicating that the login by user name DDD was deactivated (logoff), and the login has been made by user name EEE. In response to this, the information output module 104 outputs (displays) information indicating that the login by user name DDD was deactivated (logoff), and the login has been made by user name EEE.

That is, in a state in which application AP2 has already been logged in via the wireless communication of wireless communication device C3, and the away mode is executed, when user E who owns wireless communication device C5 comes closer to the application execution apparatus 10, and wireless communication device C5 enters the communication area of the communication control module 102, the application execution apparatus 10 requests to select one of wireless communication devices C3 and C5. In response to this request, when wireless communication device C3 is selected, the application execution apparatus 10 automatically continues the login to application AP2 via the wireless communication of wireless communication device C3 (to automatically continue the away mode). On the other hand, when wireless communication device C5 is selected, the application execution device 10 deactivates the login to application AP2 via the wireless communication of wireless communication device C3 (it cancels the away mode), and automatically switches to login processing to application AP1 via a wireless communication of wireless communication device C5. That is, even when a second wireless communication device enters the communication area of the communication control module 102 during the login by a first wireless communication device (during execution of the away mode), the login by the first wireless communication device can be continued (the away mode can be continued), or the login by the first wireless communication device can be switched to that by the second wireless communication device by a simple operation (the away mode is canceled and the login by the second wireless communication device can be executed).

Note that the first to fourth embodiments have explained the automatic login processing between one wireless communication device and one application execution apparatus 10 via a wireless communication. In this case, application execution control of a case in which the one wireless communication device starts a wireless communication with another application execution apparatus 10 after the automatic login processing will be described below.

A wireless communication device C, application execution apparatuses A and B, and server S will be assumed as the precondition. Application execution apparatus A has an application AP#1, and can establish a connection with the server S via a network in response to activation of application AP#1. Likewise, application execution apparatus B has an application AP#2, and can establish a connection with the server S via the network in response to activation of application AP#2. Assume that applications AP#1 and AP#2 are substantially the identical applications.

For example, the wireless communication device C and application execution apparatus A start a wireless communication, application execution apparatus A detects the wireless communication device C (identification information of the wireless communication device C), launches application AP#1, and establishes a connection with the server S, and the server S and application execution apparatus A accept a login to application AP#1 by the wireless communication device C (identification information of the wireless communication device C). Then, application execution apparatus A can receive various kinds of service information from the server S via application AP#1. That is, the user of the wireless communication device C can receive various kinds of service information from the server S via application AP#1.

Next, in a state in which application AP#1 has been logged in (for example, in a state in which the aforementioned away mode is executed), the wireless communication device C and application execution apparatus B start a wireless communication, and application execution apparatus B detects the wireless communication device C (identification information of the wireless communication device C), launches application AP#2, and establishes a connection with the server S. In this case, the server S can detect that the wireless communication device C has logged in to application AP#1 via application execution apparatus A. For this reason, after the server S deactivates the login state of the wireless communication device C to application AP#1 via application execution apparatus A, the server S and application execution apparatus B accept a login to application AP#2 by the wireless communication device C. As a result, application execution apparatus B can receive various kinds of service information from the server S via application AP#2. That is, the user of the wireless communication device C can receive various kinds of service information from the server S via application AP#2.

According to at least one of the aforementioned embodiments, an application execution apparatus and application execution method, which are excellent in application selection operability, can be provided.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. An application execution control apparatus comprising:
a memory configured to store data indicative of a relationship between a first application and a first wireless communication device, and data indicative of a relationship between a second application and a second wireless communication device;
a wireless communication module configured to execute a wireless communication with one of the first wireless communication device and the second wireless communication device; and
a controller configured to select the first application when the executed wireless communication is with the first wireless communication device, and to select the second application when the wireless communication is with the second wireless communication device.

2. The apparatus of claim 1, wherein the controller is configured to activate the first application based on the wireless communication with the first wireless communication device, and to activate the second application based on the wireless communication with the second wireless communication device.

3. The apparatus of claim 1, wherein the controller is configured to accept a login request to the first application via the wireless communication with the first wireless communication device, and to accept a login request to the second application via the wireless communication with the second wireless communication device.

4. The apparatus of claim 1, wherein the memory is configured to store a relationship between first user information and the first wireless communication device, and a relationship between second user information and the second wireless communication device.

5. The apparatus of claim 1, wherein the controller is configured to request selection of one of the first wireless communication device and the second wireless communication device when the first wireless communication device and the second wireless communication device are detected via wireless communications, and is further configured to accept a login request to the first application via the wireless communication with the first wireless communication device in response to selection of the first wireless communication device, and to accept a login request to the second application via the wireless communication with the second wireless communication device in response to selection of the second wireless communication device.

6. The apparatus of claim 5, further comprising:
a notification module configured to provide a notification of a selection request of one of the first wireless communication device and the second wireless communication device when the first wireless communication device and the second wireless communication device are detected via wireless communications.

7. The apparatus of claim 1, wherein the controller is configured to request selection of one of the first wireless communication device and the second wireless communication device when the second wireless communication device is detected during the login to the first application via the wireless communication with the first wireless communication device, to continue a login process to the first application via the wireless communication with the first wireless communication device in response to selection of the first wireless communication device, and to deactivate the login process to the first application via the wireless communication with the first wireless communication device and to accept a login request to the second application via the wireless communication with the second wireless communication device in response to selection of the second wireless communication device.

8. The apparatus of claim 1, wherein the memory is configured to store a relationship between the first wireless communication device and a first setting, and
the controller is configured to select the first application based on the wireless communication with the first wireless communication device, and to control an operation corresponding to the first application based on the first setting.

9. The apparatus of claim 1, wherein the wireless communication module is configured to support a wireless communication based on the Bluetooth Low Energy.

10. An application execution control method, the method comprising:
executing wireless communication with one of a first wireless communication device and a second wireless communication device; and
selecting a first application associated with the first wireless communication device based on the wireless communication with the first wireless communication device, and
selecting a second application stored in association with the second wireless communication device based on the wireless communication with the second wireless communication device.
